(19) United States
(12) Patent Application Publication
(10) Pub. No.: US 2025/0045019 A1
(43) Pub. Date: Feb. 6, 2025

(54) VALUE UPDATE USING PROCESS VARIATION

(71) Applicant: Micron Technology, Inc., Boise, ID (US)

(72) Inventors: Febin Sunny, Folsom, CA (US); Poorna Kale, Folsom, CA (US)

(21) Appl. No.: 18/775,961

(22) Filed: Jul. 17, 2024

Related U.S. Application Data
(60) Provisional application No. 63/517,816, filed on Aug. 4, 2023.

(51) Int. Cl. G06F 7/523; G06F 7/50

(52) U.S. Cl. CPC G06F 7/523; G06F 7/50

(57) ABSTRACT

Modifying values stored in memory cells based on process variation can include receiving process variation information for a first plurality of memory cells of a memory array. A plurality of values to be stored in the memory cells can be modified based on the process variation information. The plurality of instructions to store the plurality of values in a second plurality of memory cells can be compiled. The plurality of modified values can also be stored in a second plurality of memory cells at run time.

### PRIORITY INFORMATION

This application claims the benefit of U.S. Provisional Application No. 63/517,816, filed Aug. 4, 2023, the contents of which are included herein by reference.

### TECHNICAL FIELD

The present disclosure relates generally to apparatuses, non-transitory machine-readable media, and methods associated with updating values stored in memory cells based on process variations.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices.

Computing devices can be used to perform operations. Performing operations can utilize resources of the computing devices. Performing operations can utilize memory resources, processing resources, and power resources, for example. The operations performed can be affected by process variation of the computing devices.

### BRIEF DESCRIPTION OF THE DRAWINGS

FIG. 1 illustrates an example computing system for updating values stored in memory cells based on process variations in accordance with some embodiments of the present disclosure.

FIG. 2 illustrates graphs showing the effects of process variations in accordance with some embodiments of the present disclosure.

FIG. 3 is a functional block diagram for updating values stored in memory cells based on process variations in accordance with some embodiments of the present disclosure.

FIG. 4 is a functional block diagram of a device for updating values stored in memory cells based on process variations in accordance with some embodiments of the present disclosure.

FIG. 5 is a flow diagram corresponding to a method for updating values stored in memory cells based on process variations in accordance with some embodiments of the present disclosure.

FIG. 6 is a block diagram of an example computer system in which embodiments of the present disclosure may operate.

### DETAILED DESCRIPTION

Apparatuses, machine-readable media, and methods related to updating values stored in memory cells based on process variations are described. Process variation characteristics for a first plurality of memory cells of a memory array can be received at a computing device. The computing device can modify a plurality of values to be stored in the memory cells based on the process variation characteristics. The computing device can compile a plurality of instructions configured to store the plurality of values in a second plurality of memory cells. The computing device can also compile a plurality of instructions configured to read the plurality of values from the second plurality of memory cells and/or perform operation utilizing the plurality of values.

As used herein, “process variations” refers to the variations that memory cells undergo during processing. For example, memory cells can differ one from another based on size and/or dimensions due the variation in the processing of the memory cells. The processing of the memory cells can include the forming and/or fabrication of the memory cells.

Process variations of the memory cells can impact the voltage-conductance characteristics of the memory cells. As used herein, “voltage-conductance characteristics” refers to the mapping of voltages to conductance for memory cells. Process variations of the memory cells can impact the voltage-conductance characteristics of multiply and accumulate (MAC) units comprising the memory cells, which can impact the values being imprinted onto the memory cells (e.g., analog memory cells). The process variation can also impact the MAC operation outputs. The values being imprinted onto the memory cells can represent weights and/or biases of an artificial neural network (ANN). The ANN can be implemented by performing MAC operations. The variations in the expected output can cause errors in the final output from the ANN due to the process variations of the memory cells of the MAC. The errors represented in the ANN output can progressively accumulate over multiple iterations of the MAC operations. For example, as MAC operations are performed, the outputs of the MAC operations can include errors that are propagated from MAC operation to MAC operation.

Aspects of the present disclosure address the above and other deficiencies by updating values that are to be stored in memory cells based on the process variations of the memory cells. The values (e.g., weights) of an ANN can be recalibrated to account for the process variation of the memory cells of MAC units. Recalibrating the values (e.g., weights) of the ANN can include incrementing or decrementing the values stored in the memory cells of the MAC units to reduce the error accumulation of the MAC units. As used herein, a MAC unit includes hardware that computes the product of two inputs and adds the result of the product of the two inputs to an accumulator.

As used herein an ANN can provide learning by forming probability weight associations between an input and an output. The probability weight associations can be provided by a plurality of nodes that make up the ANN. The nodes together with weights, biases, and/or activation functions can be used to generate an output of the ANN based on the input to the ANN. A plurality of nodes of the ANN can be grouped to form layers of the ANN. An ANN can be implemented using an accelerator such as a deep learning accelerator. As used herein, a deep learning accelerator can include hardware configured to perform machine learning operation including operation utilized to implement an ANN.

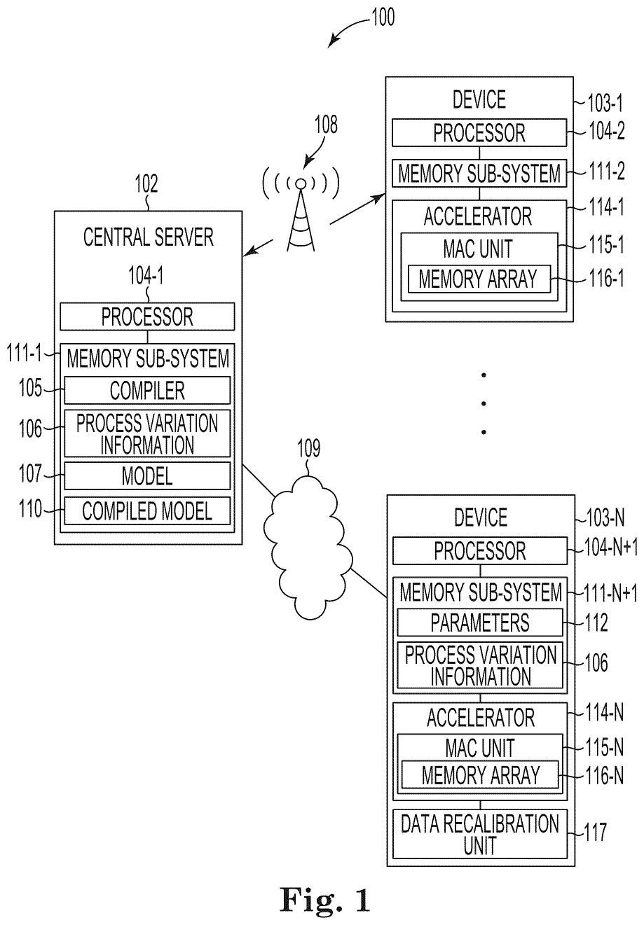

FIG. 1 illustrates an example computing system 100 for updating values stored in memory cells based on process variations in accordance with some embodiments of the present disclosure. The computing system 100 can include a server 102 and devices 103-1, 103-N (e.g., devices 103-1, 103-N), referred to herein as devices 103. The devices 103-1, 103-N can include the processors 104-2, 104-N+1, the memory sub-systems 111-2, 111-N+1, and the accelerators 114-1, 114-N. The device 103-N can include the data retention calibration unit 117. The server 102 can include the processor 104-1 and the memory sub-system 111-1.

The devices 103 can be hardware, firmware, and/or software configured to implement an artificial neural network (ANN) using accelerators 114-1, 114-N. The server 102 and the devices 103 can further include memory sub-systems 111-1, 111-2, 111-N+1 (e.g., a non-transitory MRM), referred to herein as memory sub-systems 111, on which may be stored instructions (e.g., compiler 105) and/or data (e.g., process variation information 106). Although the following description refers to a processing device and a memory device, the description may also apply to a system with multiple processing devices and multiple memory devices. In such examples, the instructions may be distributed across (e.g., stored by) multiple memory devices and the instructions may be distributed across (e.g., executed by) multiple processing devices.

The memory sub-systems 111 may include memory devices. The memory devices may be electronic, magnetic, optical, or other physical storage device that stores executable instructions. One or both of the memory devices may be, for example, non-volatile or volatile memory. In some examples, one or both of the memory devices is a non-transitory MRM comprising RAM, an Electrically-Erasable Programmable ROM (EEPROM), a storage drive, an optical disc, and the like. The memory sub-systems 111 may be disposed within a controller, the server 102, and/or the devices 103. In this example, the compiler 105 can be “installed” on the server 102. The memory sub-systems 111 can be portable, external or remote storage mediums, for example, that allow the server 102 and/or the devices 103 to download the compiler 105 from the portable/external/remote storage mediums. In this situation, the compiler 105 may be part of an “installation package.” As described herein, the memory sub-systems 111 can be encoded with executable instructions (e.g., compiler 105) for updating values stored in memory cells based on process variations using the process variation information 106.

The server 102 can execute the compiler 105 using the processor 104-1. The compiler 105 can be stored in the memory sub-system 111-1 prior to being executed by the processing device 104-1. The execution of the compiler 105 can cause values of an ANN 107 to be updated using the process variation information 106. The ANN 107 can be utilized to configure the accelerators 114-1, 114-N, referred to herein as accelerators 114.

The server 102 can execute the compiler 105 using the processor 104-1 to update values (e.g., weights) of an ANN 107 based on process variations. The values can be weight parameters (e.g., weights) of trained ANNs 107 to be deployed on the accelerator 114-N of the device 103-N. Although the ANN 107 is described as being deployed on the accelerator 114-N, the ANN 107 can be deployed on any of the accelerators 114 of the devices 103. The ANN 107 can be trained in a binary environment where process variations of memory cells used to implement the ANN 107 have a low impact on the output of the ANN 107. When the weight parameters are deployed in an analog environment, such as the accelerator 114-N, the weight parameter can be altered due to process variation. For example, a value that is stored in a memory cell can be read from the memory cell such that the value is read as a different value than was stored. Multi-bit representations of data, which are used in analog computation, can exacerbate this value alteration problem. A multi-bit representation is the use of memory cells that can be programmed to any one of more than two states. Memory cells can be programmed to any one of three or more states and are not limited to storing single-digit binary values (e.g., only one “0” or only one “1”).

The multi-bit representation of values stored in the memory cells can be defined by a parameter-to-conductance mapping. A parameter-to-conductance mapping refers to the mapping of a logical value to a conductance value of the memory cell. The impact of process variation of the memory cell on the assigned parameter-to-conductance mapping can cause error accumulation in the operations performed in the analog domain. The error accumulation can be a drop in accuracy of the ANN 107 performed using the memory cells used to store the weight parameters. For example, the ANN 107 can be comprised of multiple layers each using the MAC units 115-1, 115-N comprising the memory arrays 116-1, 116-N. As weights are read from the memory arrays 116-1, 116-N, the MAC units 115-1, 115-N can propagate errors from layer to layer leading to inaccuracies in the output of the ANN 107. To avoid errors from being propagated, the weights can be modified based on the process variations of the memory arrays 116, 116-N of the MAC units 115-1, 115-N.

For example, process variations of multiple memory arrays of a same type as the memory array 116-1 of the device 103-1 can be measured. “A type” of a memory array can refer to a type of memory cells such as volatile (e.g., DRAM) and non-volatile memory cells (e.g., NAND). “A type” of a memory array can also refer to a manufacturer of the memory and/or a model number of the memory. The memory array 116-1 can be part of the MAC unit 115-1 which is part of the accelerator 114-1. The measurements of the process variation, data describing the process variations, and/or the effects of the process variations can be described as the process variation information 106. The process variation information can be utilized in various ways to modify the weights stored in the memory array 116-N of the MAC unit 115-N. The process variation information 106 can be utilized at compile time and/or run time.

The process variation information 106 can be utilized to modify weight parameters of an ANN 107 at a time (e.g., compile time) in which instructions to implement the ANN 107 are compiled by the server 102. For instance, the process variation information 106 can be provided to the server 102 and can be stored in the memory sub-system 111-1. The server 102 can execute the compiler 105 to generate the compiled model 110 using the process variation information 106 and the ANN 107 which includes the parameters 112. The server 102 can utilize the process variation information 106 and the parameters 112 to generate updated parameters. The updated parameters can be included in the compiled model 110.

The updated parameters can be read from the memory array 116-N as the original parameters 112 even though the updated parameters and the original parameters 112 are different (e.g., have different values). The updated parameters are included in the compiled model 110. The compiled instructions which include the compiled model 110 can be provided to the device 103-N for implementing using the accelerator 114-N.

The process variation information 106 can be utilized to modify weight parameters 112 of an ANN 107 at a time in which the ANN 107 is executed (e.g., run time). For example, the data recalibration unit 117 of the device 103-N can, prior to storing the weight parameters 112 in the memory array 116-N, modify the weight parameters 112 using the process variation information 106 to generate the updated weight parameters. The updated weight parameters can be stored in the memory array 116-N to implement the ANN 107. The updated weight parameters can be read from the memory array 116-N as the weight parameters 112, where the updated weight parameters and the weights parameters 112 are different. Reading the weight parameters 112 can limit the propagation of errors due to the process variation of the memory array 116-N.

The devices 103 can include the accelerators 114-1, 114-N. Each of the accelerators 114-1, 114-N can include the MAC units 115-1, 115-N, respectively. The MAC units 115-1, 115-N can include the memory arrays 116-1, 116-N, respectively. The device 103-1 can represent a plurality of devices that are measured to determine the process variations of memory cells implemented in the MAC units. The device 103-N can represent devices in which the ANNs are implemented using accelerators (e.g., accelerator 114-N).

In various examples, the processors 104 can be internal to the memory sub-systems 111 instead of being external to the memory sub-systems 111 as shown. For instance, the processors 104 can be processor in memory (PIM) processors. The processors 104 can be incorporated into the sensing circuitry of the memory sub-systems 111 and/or can be implemented in the periphery of the memory sub-systems 111, for instance. The processors 104 can be implemented under one or more memory arrays of the memory sub-systems 111. The devices 103 can be coupled to the server 102 and/or to each other using a wireless network 108 and/or the physical network 109 to provide the process variation information 106, the ANN 107, the compiled model 110, and/or the parameters 112.

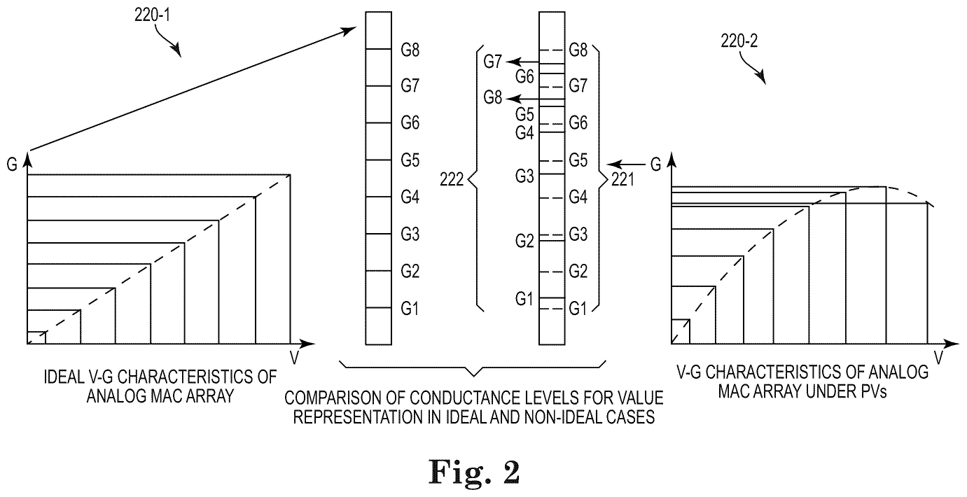

FIG. 2 illustrates graphs 220-1, 220-2 showing the effects of process variations in accordance with some embodiments of the present disclosure. The graphs 220-1, 220-2 show the voltage (V)-conductance (G) characteristics of ideal multi-level (e.g., multi-bit representation) memory cells as compared to voltage-conductance characteristics of multi-level memory cells having process variations. As used herein, multi-level memory cells are memory cells that can be programmed to any one of three or more states.

The graph 220-1 shows ideal voltage-conductance characteristics of analog MAC arrays. The term “MAC arrays” refers to memory arrays of MAC units. The voltage-conductance characteristics are characteristics of the memory cells utilized in the memory arrays of the MAC units. The graph 220-1 shows that each voltage level corresponds to a conductance level and that the relationship between voltage and conductance is linear. As voltage increases, conductance increases at the same rate. The solid lines on the graph 220-1 that intersect along the dotted line indicate the V-G values of various assigned data states. The conductance associated with each data state is also indicated on the mapping 221 as “G1”, “G2”, “G3”, “G4”, “G5”, “G6”, “G7”, and “G8”. In the ideal case illustrated by graph 220-1, the space between the data states (the difference in conductance between data states) is equal (e.g., the difference between G1 and G2 is the same as the difference between G7 and G8).

The graph 220-2 shows non-ideal voltage-conductance characteristics of analog MAC arrays that are affected by process variations. The graph 220-2 shows that each voltage level corresponds to a conductance level and that the relationship between voltage and conductance is non-linear, particularly at higher voltage levels. The difference between the voltage-conductance characteristics of graph 220-1 and graph 220-2 can be due to the process variation of the memory cells. The solid lines on the graph 220-2 that intersect along the dotted line indicate the voltage-conductance values of various assigned data states. The conductance associated with each data state is also indicated on the mapping 222 as “G1”, “G2”, “G3”, “G4”, “G5”, “G6”, “G7”, and “G8”. In the non-ideal case illustrated by graph 220-2, the space between the data states (the difference in conductance between data states) is not equal (e.g., the difference between G1 and G2 is the same as the difference between G7 and G8). Furthermore, the conductance associated with the greatest data state (G8) is actually less than the conductance associated with a lesser data state (G6). This variation can lead to sensing or reading errors.

The conductance levels of the graphs 220-1, 220-2 can be mapped to show parameter-to-conductance mappings 221, 222. The graph 220-1 can have a parameter-to-conductance mapping 221, while the graph 220-2 has a parameter-to-conductance mapping 222. The conductance levels (e.g., conductance levels G1, G2, G3, G4, G5, G6, G7, and G8) can represent a value (e.g., parameter) to conductance mapping wherein the conductance level G1 can represent a first value, the conductance level G2 can represent a second value, etc.

The parameter-to-conductance mapping 221 shows that the conductance levels are equally spaced. Equally spaced conductance levels allow for accurate values to be read from memory cells having such voltage-conductance characteristics. The parameter-to-conductance mapping 222 shows that the conductance levels are not equally spaced. For example, graph 220-2 shows that the conductance levels G4, G5, G6, G7, and G8 are not equally spaced as compared to the conductance levels G1, G2, G3, and G4. The conductance level G8 is actually lower than the conductance levels G6 and G7 where the conductance levels G1, G2, G3, G4, G5, G6, and G7 ascend. The bunching of the conductance levels G4, G5, G6, G7, and G8 creates difficulty and potential errors in reading memory cells having such voltage-conductance characteristics.

For example, an 8th value (e.g., being mapped to the G8 conductance level) can be stored in a memory cell having the voltage-conductance characteristics shown in graph 220-2. However, a 6th value can be read from the memory cell due to the process variation of the memory cells. The 6th value can be read because the 8th value stored in the memory cell can be in a 6th position corresponding to a 6th value in the parameter-to-conductance mapping 222. The reading of the 6th value from the memory cell can be an error given that an 8th value was intended to be stored and read from the memory cell. The error caused by reading incorrect values from the memory cells can contribute to the propagation of errors in ANNs due to process variations in the memory cells of the memory array of the MAC units.

The examples described herein can address the errors caused by the process variations of the memory cells by incrementing or decrementing the values stored in the memory cells with an understanding that a different value will be read from the memory cell. For instance, an 8th value intended to be stored and read from the memory cell can be modified to be a 7th value. The 8th value can be decremented to be a 7th value and the 7th value can be stored in the memory cell. The memory cell can be read to retrieve an 8th value because the conductance level G7 is in an 8th position in the parameter-to-conductance mapping 222. Although a particular parameter-to-conductance mapping 222 is shown in FIG. 2, different parameters-to-conductance mappings can be used to modify values stored in memory cells to prevent the propagation of errors in an ANN due to process variations of the memory cells used in the MAC units used to implement the ANN.

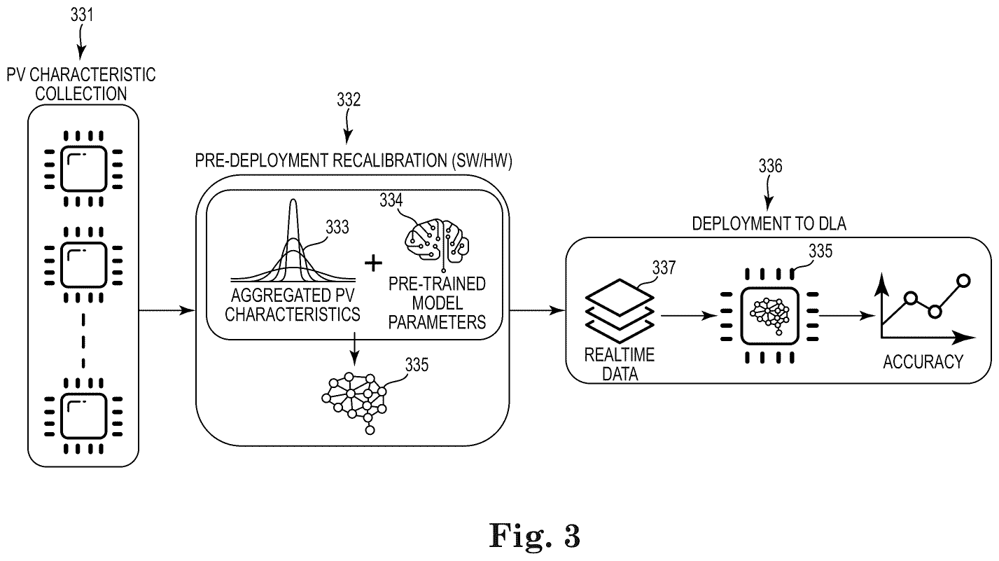

FIG. 3 is a functional block diagram for updating values stored in memory cells based on process variations in accordance with some embodiments of the present disclosure. FIG. 3 shows the updating of values in a compiler prior to run time. FIG. 3 shows the process variation collection 331, the pre-deployment calibration 332, and the deployment 336 to a deep learning accelerator (DLA).

The process variation collection 331 can include the collection of process variation information from multiple memory sub-systems across multiple devices. Process variation information can be gathered for each memory array from a plurality of devices. The memory sub-systems and/or the devices comprising the memory sub-systems can be from a same manufacturer and/or a same model or then can of a different manufacturer and/or a different model. The process variation information can be collected at a system such as system 102 of FIG. 1.

The process variation collection 331 can be performed to generate process variation characteristics 333. The process variation information can be utilized to generate the process variation characteristics 333 for a memory cell, an array of memory cells, or multiple memory sub-systems. In various examples, the process variation characteristics 333 can be general given that it may not be known what memory array (e.g., manufacturer and model) is to be used to store weight parameters of an ANN.

The process variation characteristics 333 can be utilized to modify pre-trained model parameters 334 of an ANN. The parameters (e.g., weight parameters) 334 of an ANN may be referred to as pre-trained in that the ANN can be trained without modifying the parameters according to the process variation characteristics 333. In other words, the parameters 334 are the result of training the ANN to perform its desired function, but without adjusting the parameters 334 for the process variation characteristics 333. The modification of the parameters 334 utilizing the process variation characteristics 333 can be referred to as a training (different from the initial training of the ANN) or fitting of the parameters 334 to a memory sub-system, memory array, and/or memory cells. A compiler can modify the parameters 334 utilizing the process variation characteristics 333 to generate an adjusted ANN 335 (e.g., the same ANN, but with the weights adjusted according to the process variation characteristics 333).

The adjusted ANN 335 can be deployed 336 to an accelerator (e.g., DLA). For example, the adjusted parameters can be stored in a memory array of a MAC unit of the accelerator. The adjusted ANN including the adjusted parameters can be utilized by the MAC unit to perform operations utilizing input data 337 and/or data provided by different layers of the ANN. Modifying the parameters 334 according to the process variation characteristics 333 can increase an accuracy of the ANN as compared to utilizing the parameters 334 (without adjustment) to implement the ANN.

The compiler can modify the parameters 334 at compile time such that the accelerator implementing the ANN is not aware that the parameters have been modified to fit the process variation of the memory arrays utilized in the MAC units. Additionally, the compiler may not be aware of the specific memory array utilized to store the parameters which may limit the ability of the compiler to utilize process variation characteristics 333 that correspond uniquely to the memory array. Instead, the compiler may rely on generic process variation characteristics 333 which may still be applicable to the use of the memory arrays of an accelerator, but which may not address potential errors at the DLA in exchange for the convenience of modifying the parameters 334 at the controller.

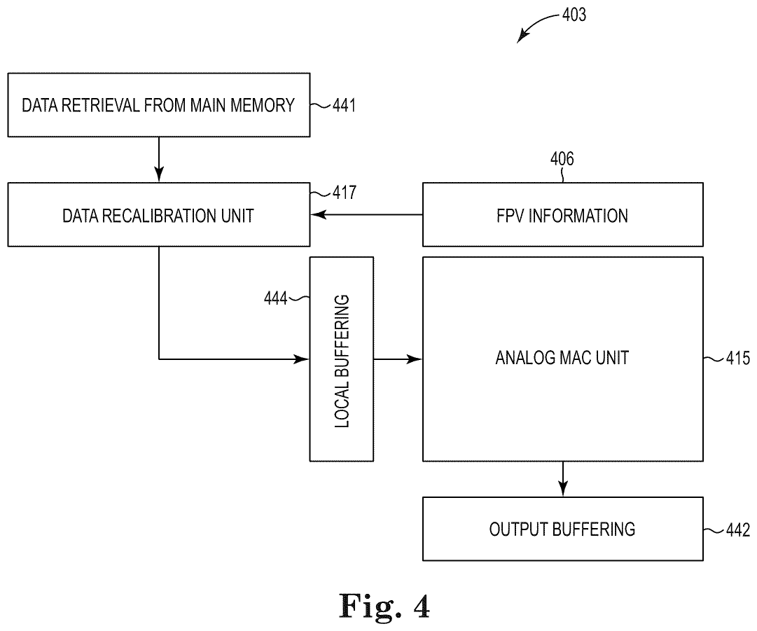

FIG. 4 is a functional block diagram of a device 403 for updating values stored in memory cells based on process variations in accordance with some embodiments of the present disclosure. The device 403 includes a data recalibration unit 417, a local buffer 444, a MAC unit 415, and an output buffer 442. The device 403 can be utilized to update values stored in memory cells at run time. The values can be updated based on process variations of the memory cells of the MAC unit 415.

The MAC unit 415 and/or the data recalibration unit 417 can be part of an accelerator (e.g., DLA). The MAC unit 415 and the data recalibration unit 417 can be hardware. The data recalibration unit 417 can receive data 441 retrieved from memory. For example, the data recalibration unit 417 can receive weight parameters of an ANN. The weight parameters can be retrieved from a memory sub-system that is different from the MAC unit 415 and/or the memory array in the MAC unit 415. The memory sub-system can be part of the device 403 or can be external to the device 403.

The data recalibration unit 417 can receive process variation information 406 (e.g., FPV information). The process variation information 406 can also be retrieved from a memory sub-system. The memory sub-system that stored the process variation information 406 can be a same memory sub-system that stores the data 441 or can be a different memory sub-system from the memory sub-system that stores the data 441.

The data recalibration unit 417 can adjust the weights (e.g., data 441) utilizing the process variation information 406. For example, the data recalibration unit 417 can generate process variation characteristics from the process variation information 406. The process variation characteristics can be utilized to generate a conductance-parameter mapping that can be used to adjust the weights. For example, the process variation information 406 refers to the process variation of the memory cells of the MAC unit 415 including variations in size of the memory cells of the MAC unit 415 as compared to the dimensions of ideal memory cells. The process variation information 406 can be utilized to generate process variation characteristics that can describe the conductance levels relative to the voltage levels. The process variation characteristics can be utilized to map values that the memory cells can store to conductance levels as described by the conductance-parameter mapping. The conductance-parameter mapping can be utilized to modify the weights.

In various instances, the process variation information 406 can include the process variation characteristics and/or the conductance-parameter mappings. For example, the conductance-parameter mapping corresponding to the memory cells of the MAC unit 415 can be generated by a processing device of the device 403 and/or by a processing device external to the memory device 403. The conductance-parameter mapping can be provided to the data recalibration unit 417, The data recalibration unit 417 can modify the weights without performing additional computations on the conductance-parameter mapping.

The modified weights can be provided to the MAC unit 415. For example, the data recalibration unit 417 can provide the modified weights to the local buffer 444. The local buffer 444 can provide the modified weights to the MAC unit 415. The modified weights can be stored in a memory array of the MAC unit 415.

In various examples, the MAC unit 415 can be used to perform operations consistent with the execution of the ANN implemented by the accelerator which includes the MAC unit 415. For example, after storing the weights in the MAC unit 415, the MAC unit 415 can receive input data and can perform a number of operations using the input data and the weights. The output of the MAC unit 415 can be stored in the output buffer 442. The output can be provided as an input to a different MAC unit 415 or as a final output of the ANN.

The modified weights can be stored in the MAC unit 415 at run time given that the weights are modified in a same device 403 as is used to store the weights in the MAC unit 415. The process variation information 406 can be more specific to the memory cells of the MAC unit 415 than the process variation information utilized at compile time to modify the weights at compile time. The process variation information 406 can be specific to the memory cells of the MAC unit 415 because the memory cells are known (e.g., manufacturer and/or model of the memory cells is known). Knowledge of the memory cells can allow for a selection of process variation information 406 that is directly pertinent to the memory cells. Process variation information 406 can be directly pertinent to the memory cells of the MAC unit 415 if the process variation information 406 was gathered from memory cells having a same manufacturer and/or model as the memory cells of the MAC unit 415. Utilizing process variation information 406 from memory cells that have a same manufacturer and/or model as the memory cells utilized in the MAC unit 415 can allow for a greater accuracy than utilizing process variation information 406 that was gathered from memory cells having different manufacturers and/or models as the memory cells of the MAC unit 415.

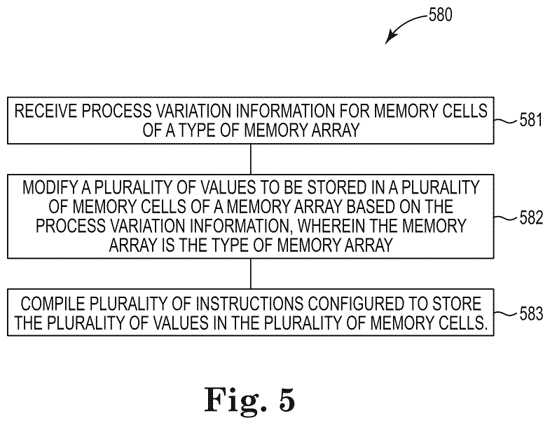

FIG. 5 is a flow diagram corresponding to a method 580 for updating values stored in memory cells based on process variations in accordance with some embodiments of the present disclosure. The method 580 may be performed, in some examples, using a computing system such as those described with respect to FIG. 1.

At 581, process variation information 106 for memory cells of a type of memory array 116-1 can be received. The process variation information 106 can be received at a compiler 105 of a system (e.g., computing system). At 582, a plurality of values to be stored in the memory cells of a memory array 116-1 can be modified based on the process variation information 106, where the memory is the type of memory array. The plurality of values can be modified by incrementing or decrementing the plurality of values. The plurality of values can be incremented or decremented based on the process variation information 106 of memory cells of a MAC unit 115-1 which is measured. At 583, a plurality of instructions configured to store the plurality of values in the plurality of memory cells can be compiled. The instructions compiled 110 can include instructions for storing the plurality of values after the plurality of values have been modified by incrementing or decrementing the plurality of values. The plurality of memory cells can also be part of a MAC unit 115-N of an accelerator 114-N that is different from a MAC unit 115-1 that is measured, wherein the MAC unit 115-1 that is measured is included in a different accelerator 114-1.

The type of memory array can correspond to a MAC unit. The process variation characteristics can be generated for the MAC unit that is measured. The MAC unit can be part of an accelerator. Receiving the process variation information for a MAC unit can include receiving process variation information for memory cells and/or memory arrays that can be utilized in a MAC unit. The process variation information may not be unique to the memory cells and/or memory arrays utilized in the MAC unit but can include multiple different types of memory cells and/or memory arrays that can be utilized in the MAC units. The process variation information can include size and dimension characteristics of the memory cells of the type of memory array.

The process variation information can be utilized to generate a conductance-value mapping. In various examples, the process variation information can include a conductance-value mapping. The “conductance-value mapping” is a mapping between a conductance of a memory cell and a value that the memory cells is determined to store. The conductance-value mapping can also be referred to as conductance-parameter mapping. The plurality of values can be modified based on the conductance-value mapping. In various instances, the controller can generate the conductance-value mapping and/or can receive the conductance-value mapping that was generated by a different processing device.

In various examples, a data recalibration unit can receive a plurality of weights of an ANN from a first memory array. The first memory array can be a main memory of a memory device. The plurality of weights of the ANN may be received from a memory other than the memory included in the MAC units. The memory of the MAC units may be insufficient to store the entirety of the ANN (e.g., weights of the ANN). The weights of the ANN can be read from the main memory and stored in a memory of the MAC unit as the weights are needed by the MAC unit. The weights can be updated after being read from the main memory and before being stored in a memory of the MAC unit.

The data recalibration unit can also receive process variation information. The process variation information can also be retrieved from the first memory array or from a different memory array. The first memory array and the different memory array can be internal to the device comprising the data recalibration unit or external to the device comprising the data recalibration unit. The data recalibration unit can update the plurality of weights based on the process variation information. The plurality of weights can be updated by incrementing or decrementing values that represent the plurality of weights. The data recalibration unit can store the plurality of updated weights in a second memory array of a MAC unit.

An accelerator can include the MAC unit. The accelerator can be configured to implement the ANN. For example, the accelerator can be a DLA.

The process variation information can include process variation characteristics. The data recalibration unit can receive the process variation information that includes the process variation characteristics. The process variation characteristics can correspond to the MAC unit. For example, the process variation characteristics can correspond to memory cells and/or memory arrays of the MAC unit. The process variation information can include a conductance-value mapping.

The data recalibration unit can update the plurality of weights based on the conductance-value mapping. The plurality of weights can be updated based on the conductance-value mapping to cause the plurality of updated weights to be read from the MAC unit as the plurality of weights, where the updated weights are different from the plurality of weights. For example, the plurality of updated weights can be stored in memory cells of the MAC unit with an understanding that the memory cells of the MAC unit, when read, can provide the plurality of weights and not the plurality of updated weights.

The plurality of plurality of updated weights can be stored in a local buffer coupled to the MAC unit to store the plurality of updated weights in the second memory array of the MAC unit. In various instances, the local buffer can be used to hold the weights that are to be stored in the MAC unit. In various instances, the plurality of updated weights can be generated and saved in the buffer so as to prevent the storage of the updated weights from being delayed due to the generation of the updated weights. For example, the buffer can retain an order of the data stored in the buffer. The buffer can be a first in first out (FIFO) buffer. A placeholder can be inserted into the FIFO while the update weights are being generated. After the updated weights are generated, the updated weights can be inserted at the placeholder so as to refrain from delaying the providing of the updated weights to the MAC unit.

In various instances, a conductance-parameter mapping included in the process variation information of memory cells of a plurality of multiply and accumulate (MAC) units can be received at a compiler. A plurality of parameters, of an ANN, to be stored in the memory cells can be modified based on the conductance-parameter mapping. The conductance-parameter mapping can also be referred to as conductance-value mapping. A plurality of instructions configured to store the plurality of values in a second plurality of memory cells of a different MAC unit can be compiled. The compiled instructions can be utilized at run time to store the plurality of values in the MAC unit.

A plurality of weights of the ANN to be stored in the memory cells can be modified based on the conductance-parameter mapping. Modifying the plurality of weights can include modifying values that represent the weights. The values can include, for example, bit values or different kinds of values comprising anyone of three or more values. The process variation information can include voltage-to-conductance characteristics of the memory cells. The plurality of parameters can be trained in a binary environment and are implemented in an analog environment. As used herein, a binary environment describes an environment where values that represent the weights can have a binary value. An analog environment describes an environment where values that represent the weights can have any one of three or more values. Binary environments may experience less errors due to process variation as compared to analog environments. The greater the quantity of values a memory cell can store, the greater the probability of errors being experienced when reading the memory cell.

The conductance-parameter mapping can be generated to update a quantization distribution corresponding to the second plurality of memory cells. A quantization distribution describes how the threshold conductance levels are distributed in relation to the voltage levels of memory cells. In various instances, the quantization distribution of conductance thresholds can be modified by process variations. A first quantization distribution can be intended while a second quantization distribution is implemented in memory cells due to process variations. The further the first quantization distribution is from the second quantization distribution the greater the number of errors that can be experienced when reading values from memory cells.

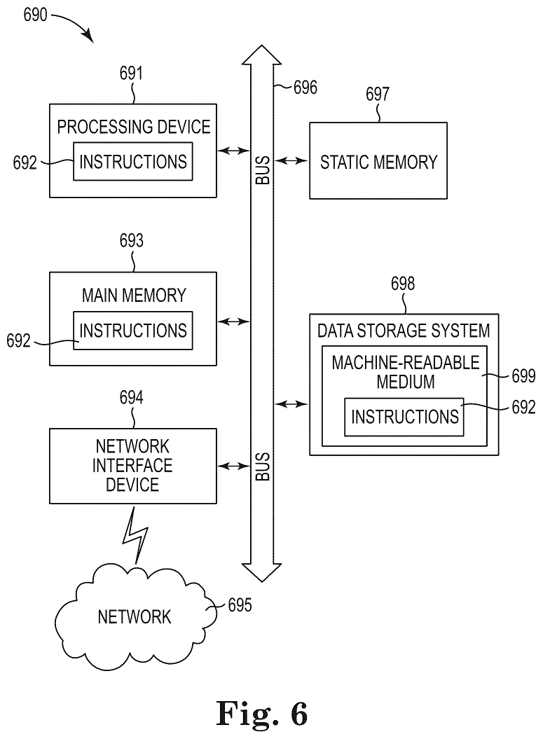

FIG. 6 is a block diagram of an example computer system 690 in which embodiments of the present disclosure may operate. For example, FIG. 6 illustrates an example machine of a computer system 690 within which a set of instructions, for causing the machine to perform any one or more of the methodologies discussed herein, can be executed. In some embodiments, the computer system 690 can correspond to a host system that includes, is coupled to, or utilizes a memory sub-system (e.g., the memory sub-systems 111-1, 111-2, 111-N+1 of FIG. 1). The computer system 690 can be used to perform the operations described herein (e.g., to perform operations corresponding to the processors 104-1, 104-2, 104-N+1 and/or the data recalibration unit 117 of FIG. 1). In alternative embodiments, the machine can be connected (e.g., networked) to other machines in a LAN, an intranet, an extranet, the Internet, and/or wireless network. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device (e.g., processor) 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 698, which communicate with each other via a bus 696.

The processing device 691 represents one or more general-purpose processing devices such as a microprocessor, a central processing unit, or the like. More particularly, the processing device 691 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 694 to communicate over the network 695.

The data storage system 698 can include a machine-readable storage medium 699 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media. The machine-readable storage medium 699, data storage system 698, and/or main memory 693 can correspond to the memory sub-systems 111-1, 111-2, 111-N+1 of FIG. 1.

In one embodiment, the instructions 692 include instructions to implement functionality corresponding to examples described herein (e.g., using processors 104-1, 104-2, 104-N+1 and/or the data recalibration unit 117 of FIG. 1). While the machine-readable storage medium 699 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising,
receiving process variation information for memory cells of a type of memory array;
modifying a plurality of values to be stored in a plurality of memory cells of a memory array based on the process variation information, wherein the memory array is the type of memory array; and
compiling a plurality of instructions configured to store the plurality of values in the plurality of memory cells.

2. The method of claim 1, wherein the type of memory array corresponds to a multiply and accumulate (MAC) unit.

3. The method of claim 2, further comprising receiving the process variation information for the MAC unit in an accelerator.

4. The method of claim 1, wherein the process variation information is generated based on size and dimension information of the first plurality of memory cells.

5. The method of claim 1, wherein the process variation information includes conductance-value mapping.

6. The method of claim 5, further comprising modifying the plurality of values based on the conductance-value mapping.

7. The method of claim 1, wherein the plurality of memory cells corresponds to a MAC unit of an accelerator.

8. An apparatus comprising:
a data recalibration unit configured to:
receive a plurality of weights of an artificial neural network (ANN) from a first memory array;
receive process variation information;
update the plurality of weights based on the process variation information; and
store the plurality of plurality of updated weights in a second memory array of a multiply and accumulate (MAC) unit.

9. The apparatus of claim 8, further comprising an accelerator comprising the MAC unit, wherein the accelerator is configured to implement the ANN.

10. The apparatus of claim 8, wherein the data recalibration unit is configured to receive the process variation information comprising process variation characteristics.

11. The apparatus of claim 10, wherein the process variation characteristics corresponds to the MAC unit.

12. The apparatus of claim 10, wherein the process variation information includes a conductance-value mapping.

13. The apparatus of claim 12, wherein the data recalibration unit is configured to update the plurality of weights based on the conductance-value mapping.

14. The apparatus of claim 13, wherein the data recalibration unit is configured to update the plurality of weights based on the conductance-value mapping to cause the plurality of updated weights to be read from the MAC unit as the plurality of weights.

15. The apparatus of claim 8, wherein the data recalibration unit is configured to store the plurality of plurality of updated weights in a local buffer coupled to the MAC unit to store the plurality of updated weights in the second memory array of the MAC unit.

16. The apparatus of claim 8, wherein the first memory array is a main memory of the apparatus.

17. A non-transitory machine-readable medium having computer-readable instructions, which when executed by a computer, cause the computer to:
receive a conductance-parameter mapping generated from process variation information of memory cells of a plurality of multiply and accumulate (MAC) units;
modify a plurality of parameters, of an artificial neural network (ANN), to be stored in the memory cells based on the conductance-parameter mapping; and
compile a plurality of instructions configured to store the plurality of values in a second plurality of memory cells of a different MAC unit.

18. The machine-readable medium of claim 17, wherein the instructions are further executable to modify a plurality of weights of the ANN to be stored in the memory cells based on the conductance-parameter mapping.

19. The machine-readable medium of claim 17, wherein the process variation information includes voltage-to-conductance information of the memory cells.

20. The machine-readable medium of claim 17, wherein the plurality of parameters are trained in a binary environment and are implemented in an analog environment.

21. The machine-readable medium of claim 17, wherein the instructions are further executable to generate the conductance-parameter mapping to update a quantization distribution corresponding to the second plurality of memory cells.
